(19) United States
(12) Patent Application Publication
(10) Pub. No.: US 2018/0130035 A1
(43) Pub. Date: May 10, 2018

(54) ADVANCED CASH RESERVATION SYSTEM IN ATMS

(71) Applicant: CA, Inc., New York, NY (US)

(72) Inventors: Narendra DHULIPALLA, Hyderabad (IN); Madhusudhan GANDA, Bangalore (IN); Sumit GUPTA, Bangalore (IN); Ramanuja CHARYULU, East Setauket, NY (US); Kiran KUMAR B.S., Bangalore (IN); Swapnel SHRIVASTAVA, Bangalore (IN)

(73) Assignee: CA, Inc.

(21) Appl. No.: 15/347,320

(22) Filed: Nov. 9, 2016

(51) Int. Cl. G06Q 20/10; G06Q 40/02; H04W 4/14; G06Q 20/40; H04W 4/02; G06Q 20/32

(52) U.S. Cl. CPC G06Q 20/10; G06Q 20/1085; G06Q 40/02; G06Q 20/3223; G06Q 20/40; H04W 4/02; H04W 4/14

(57) ABSTRACT

A method includes determining whether a transaction request associated with an account would clear the account if the transaction request is processed. The method further comprising determining whether a particular Automated Teller Machine (ATMs) has sufficient resources to service the transaction request. The method further comprising transmitting an instruction reserving a corresponding amount of currency for the transaction request at the particular ATM for a predetermined time frame.

### BACKGROUND

The present disclosure relates to reserving monetary funds, and, more specifically, to systems and methods for reserving currency at a particular Automated Teller Machine (ATM) based on a transaction request received from an account-holder.

Banks, credit unions, and other financial institutions require access to cash to meet the fluctuating demand requirements of their customers. Certain cash-points associated with a financial institution may, over time, receive a large number of withdrawal requests, contributing to a shortfall in currency reserves at that location. Other cash-points may receive a disproportionate number of cash deposits, and accumulate substantial cash reserves. This imbalance of reserve currency, vault cash, or cash-on-hand presents a variety of risks and inefficiencies for banks as well as bank customers seeking withdraws from cash-points such as ATMs.

Allocation of cash reserves throughout a financial institution's cash-points is critical to accommodating large cash withdrawals and other customer requests. Unexpected increases in currency demand in disparate geographic regions may cause currency shortages in certain bank locations. Unpredictable currency shortages are not only inefficient for financial institutions but also frustrating for consumers who expect all cash-points to be capable of fulfilling any transaction request. Further, not all currency is equally desirable for every purpose. Fulfillment of certain currency demand requests requires delivery of a particular caliber or quality of banknote. For example, ATM's require higher quality currency.

Technology in the field of currency processing systems has yielded advancements in currency counting, counterfeit detection, and fitness calculation, enabling most businesses to obtain devices that automatically count, sort, and account for cash inventories. In addition, financial institutions have improved customer technology thereby increasing customer communications. Particular devices may be capable of connecting to a network and providing output to a software system.

In certain currency processing systems, deposited banknotes are analyzed for integrity and quality. If the system determines that banknote or other currency object cannot be read properly, is damaged, is counterfeit, or is otherwise unfit for continued circulation, the system will generally reject the banknote or currency object for second review of the note. These systems may track deposited notes by serial number or other identifier, and store information regarding accepted and rejected notes in a database. Thus, certain cash management systems may have invoicing and tracking functionality for monitoring deposited banknotes. These systems may be implemented at various cash centers within a financial institution.

In the past several decades, the use of machines to count, sort and validate currency has expanded significantly in terms of both quantity and breadth of functionality. Some machines are used to count, sort, authenticate, capture serial numbers, evaluate fitness and even destroy banknotes (where this is authorized) at speeds up to or exceeding 44 banknotes per second. Output from these devices can be used to monitor currency deposits at various cash-points within a financial institution.

Systems and methods described herein may enable a user to reserve currency at a particular ATM. The present disclosure describes systems and methods for determining whether a transaction request associated with an account would clear the account if the transaction request is processed. The systems and methods may further determine whether a particular ATM has sufficient resources to service the transaction request. Further, the systems and methods herein may transmit an instruction reserving a corresponding amount of currency for the transaction request at the particular ATM for a predetermined time frame.

### BRIEF SUMMARY

According to an aspect of the present disclosure, a method may include several processes. In particular, the method may include determining whether a transaction request associated with an account would clear the account if the transaction request is processed. The method may also include determining whether a particular ATM has sufficient resources to service the transaction request. The method may further include transmitting an instruction reserving a corresponding amount of currency for the transaction request at the particular ATM for a predetermined time frame.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements of a non-limiting embodiment of the present disclosure.

FIG. 1 is a schematic representation of a transaction system ecosystem of a non-limiting embodiment of the present disclosure.

FIG. 2 is a schematic representation of a transaction system configured to interact with the transaction system ecosystem.

FIG. 3 illustrates communication points in a transaction system ecosystem according to a non-limiting embodiment of the present disclosure.

FIG. 4 is a flow chart for a method for determining a valid transaction request and reserving currency at a particular ATM according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Each activity in the present disclosure may be executed on one, some, or all of one or more processors. In some non-limiting embodiments of the present disclosure, different activities may be executed on different processors.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to reserving currency at a particular ATM, systems and methods disclosed herein may be related to any field involving limited resources due to an unpredictable spike in demand. Moreover, certain examples disclosed herein may be described with respect to consumer or business solutions, or any other field that may involve reservation of goods. Certain embodiments described in the present disclosure are merely provided as example implementations of the processes described herein.

Financial institutions strive to provide their customers access to funds in multiple locations. ATMs are deployed for quick access to cash at the customer's convenience. However, the presence of an ATM does not guarantee that funds will be available at all times. In some countries, ATMs often run out of funds at popular locations or during heavy withdraw times. As a result, customers often experience tension and anxiety.

Systems and methods disclosed herein aim to increase customer satisfaction and more efficiently allocate resources by providing a system to reserve currency at a cash-point of a financial institution. Systems and methods disclosed herein may involve a financial institution receiving a transaction request form a user associated with an account at the financial institution. The financial institution may determine whether the transaction request would clear the account should it be processed. In addition, systems and methods herein may determine whether a particular ATM has sufficient resources to service the transaction request. Further, systems and methods herein may transmit an instruction reserving a corresponding amount of currency for the transaction request at the particular ATM for a predetermined time frame.

The teachings of the present disclosure may reference specific example “device.” For example, an “device” can include may refer to a smartphone, tablet, desktop computer, laptop, Global Positioning System (GPS) device, satellite communication terminal, radio communication terminal, or any other device capable of receiving input. For example, a mobile device may be equipped with an application capable of communicating with a financial institution. Any device with such capabilities is contemplated within the scope of the present disclosure.

In a first example, systems and methods disclosed herein may determine whether a transaction request associated with an account would clear the account if the transaction request is processed. Systems and methods disclosed herein may further determine whether a particular ATM has sufficient resources to service the transaction request. Systems and methods herein may also transmit an instruction reserving a corresponding amount of currency for the transaction request at the particular ATM for a predetermined time frame.

In a second example, non-limiting embodiments of the present disclosure may include a processing system configured to perform processes including determining whether a transaction request associated with an account would clear the account if the transaction request is processed. Further, the processing system may be configured to perform processes including, for each of a plurality of Automated Teller Machines (ATMs), determining whether the ATM has sufficient resources to service the transaction request. In addition, the processing system may be configured to perform processes including transmitting a set of ATMs having sufficient resources to a user associated with the account. The processing system may also be configured to perform processes including transmitting an instruction reserving a corresponding amount of currency for the transaction request for a predetermined time frame at a particular ATM selected by the user from the set.

In a third example, systems and methods disclosed herein may determine whether a transaction request associated with an account would clear the account if the transaction request is processed. Further, systems and methods disclosed herein may, for each of a plurality of Automated Teller Machines (ATMs) within a predetermined range of a current location of a user associated with the account, determine whether the ATM has sufficient resources to provide a particular set of currency requested in the transaction request. Systems and methods disclosed herein may transmit to the user associated with the account a set of ATMs having sufficient resources within the predetermined range of the current location of the user. Systems and methods disclosed herein may also transmit an instruction reserving the particular set of currency for a predetermined time at a particular ATM selected by the user from the set of ATMs.

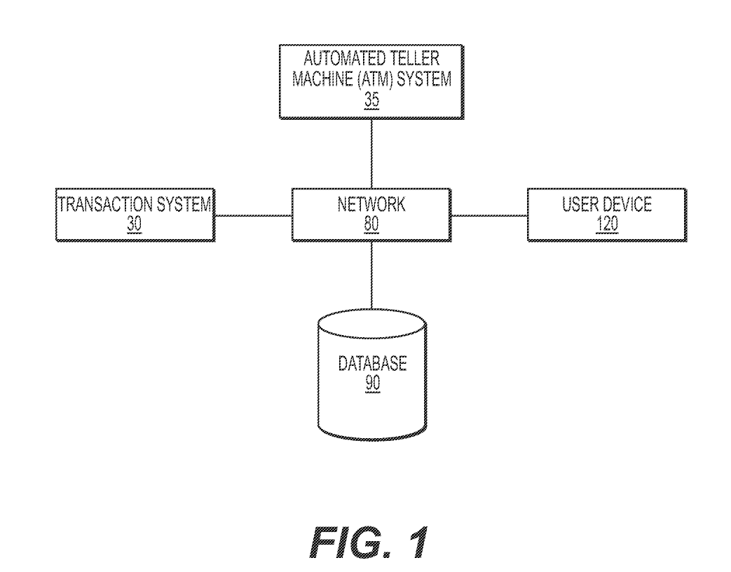

FIG. 1 is a schematic representation of a transaction system ecosystem of a non-limiting embodiment of the present disclosure. A transaction system 30 may communicate with a database 90 and user device 120 via a network 80. Further, transaction system 30 may communicate with an ATM system 35 via the network 80. In some non-limiting embodiments of the present disclosure, ATM system 35 may include a single ATM. In other non-limiting embodiments of the present disclosure, ATM system 35 may include multiple ATMs. In some non-limiting embodiments of the present disclosure, transaction system 30 may directly communicate with user device 120 if transaction system 30 is installed on the user device 120. User device 120 may be a mobile device with an application capable of communicating with transaction system 30.

Network 80 may comprise one or more entities, which may be public, private, or community based. Network 80 may permit the exchange of information and services among users/entities that are connected to such network 80. In certain configurations, network 80 may be a local area network, such as an intranet. Further, network 80 may be a closed and/or private network/cloud in certain configurations, and an open network/cloud in other configurations. Network 80 may facilitate wired or wireless communications of information and provisioning of services among users that are connected to network 80.

Network 80 may comprise one or more clouds, which may be public clouds, private clouds, or community clouds. Each cloud may permit the exchange of information and the provisioning of services among devices and/or applications that are connected to such clouds. Network 80 may include a wide area network, such as the Internet; a local area network, such as an intranet; a cellular network, such as a network using CDMA, GSM, 3G, 4G, LTE, or other protocols; a machine-to-machine network, such as a network using the MQTT protocol; another type of network; or some combination of the aforementioned networks. Network 80 may be a closed, private network, an open network, or some combination thereof and may facilitate wired or wireless communications of information among devices and/or applications connected thereto.

Network 80 may include a plurality of devices, which may be physical devices, virtual devices (e.g., applications running on physical devices that function similarly to one or more physical device), or some combination thereof. The devices within network 80 may include, for example, one or more of general purpose computing devices, specialized computing devices, mobile devices, wired devices, wireless devices, passive devices, routers, switches, mainframe devices, monitoring devices, infrastructure devices, other devices configured to provide information to and/or receive information from service providers and users, and software implementations of such.

In some non-limiting embodiments of the present disclosure, user device 120 may be any type of computer such as a desktop computer. In other non-limiting embodiments, user device 120 may be a mobile device such as a mobile phone, laptop, tablet, any portable device, etc. Mobile electronic devices may be part of a communication network such as a local area network, wide area network, cellular network, the Internet, or any other suitable network. Mobile devices may be powered by a mobile operating system, such as Apple Inc.'s iOS® mobile operating system or Google Inc.'s Android® mobile operating system, for example. A mobile electronic device may use a communication network to communicate with other electronic devices, for example, to access remotely-stored data, access remote processing power, access remote displays, provide locally-stored data, provide local processing power, or provide access to local displays. For example, networks may provide communication paths and links to servers, which may host applications, content, and services that may be accessed or utilized by users via mobile electronic devices. The content may include text, video data, audio data, user settings or other types of data. Networks may use any suitable communication protocol or technology to facilitate communication between mobile electronic devices, such as, for example, BLUETOOTH, IEEE WI-FI (802.11a/b/g/n/ac), or Transmission Control Protocol/Internet Protocol (TCP/IP).

In addition, transaction system 30 may use network 80 to communicate with a user device 120. In some non-limiting embodiments of the present disclosure, user device 120 may communicate with transaction system 30 via network 80. In some non-limiting embodiments of the present disclosure, transaction system 30 may be located on user device 120 associated with a user, and transaction system 30 may support communications between the user device 120 and a financial institution. In some non-limiting embodiments of the present disclosure, transaction system 30 may authenticate a user identity of a user on the user device 120 in order to streamline transaction requests to a financial institution.

In some non-limiting embodiments, user device 120 may communicate with transaction system 30 using a cellular network, such as 3G or LTE, for example, or other communication protocols or methods, such as Wi-Fi or NFC, for example. Further, user device 120 may include one or more applications that provide a user interface, which may display alerts, alarms, and/or notifications associated with transaction system 30 disclosed herein, and which may provide one or more options for interaction with transaction system 30.

The transaction system 30 environment may also include a database 90. Database 90 may include, for example, additional servers, data storage, and resources. Transaction system 30 may receive additional data, account information, previously fulfilled transaction requests, ATM usage histories, ATM current currency and denomination status, or any data used by transaction system 30 from database 90. Database 90 may be any conventional database or data infrastructure. For example, database 90 may include scaled out data architectures (i.e., Apache Hadoop) and/or persistent, immutable stores/logging systems.

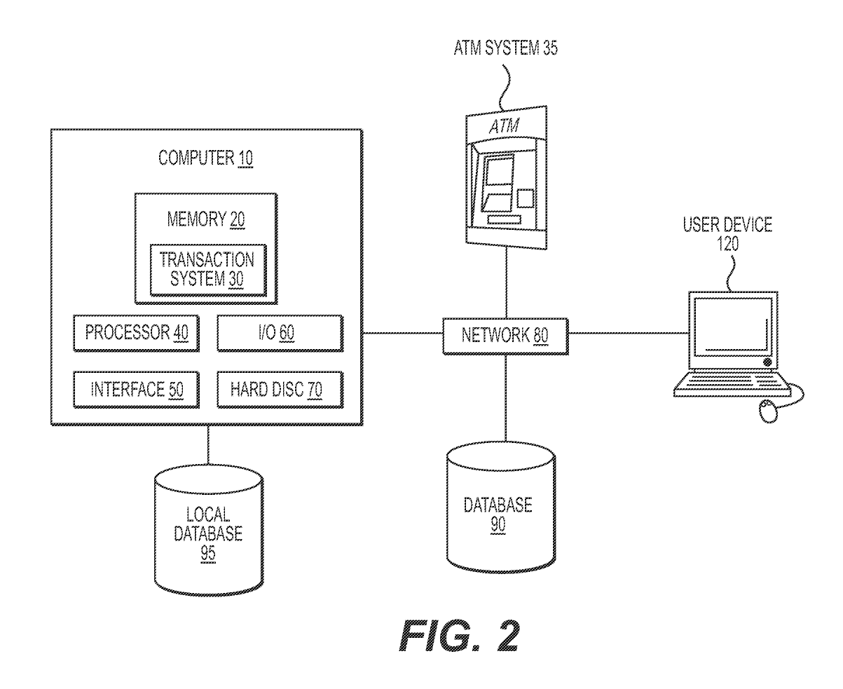

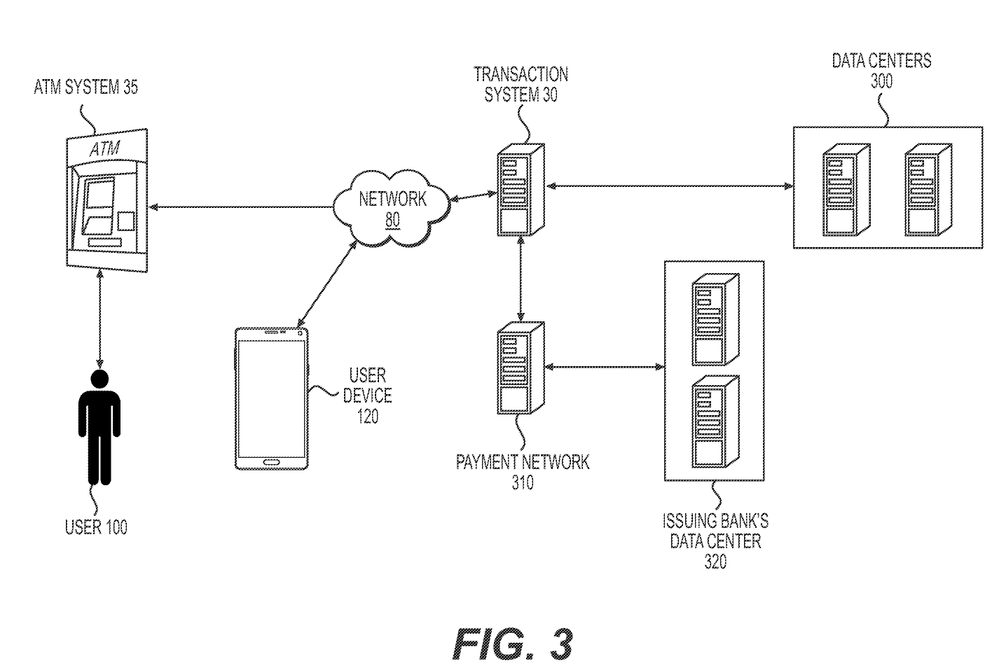

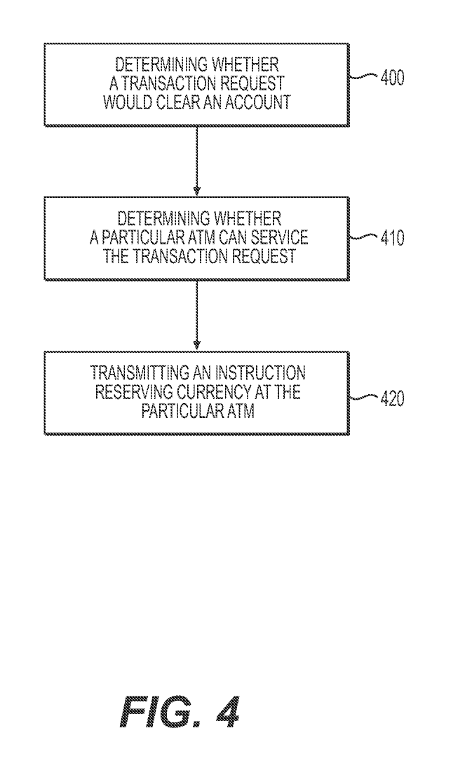

Referring to FIG. 2, the transaction system 30 of a non-limiting embodiment of the present disclosure is displayed. Computer 10 may reside on one or more networks. In some non-limiting embodiments, computer 10 may be located on any device that may receive input from a device, such as, for example, a mobile device or user device 120. Computer 10 may comprise a memory 20, a central processing unit, an input and output (“I/O”) device 60, a processor 40, an interface 50, and a hard disk 70. Memory 20 may store computer-readable instructions that may instruct computer 10 to perform certain processes. In particular, memory 20 may store a plurality of application programs that are under development. Memory 20 also may store a plurality of scripts that include one or more testing processes for evaluation of applications or input. When computer-readable instructions, such as an application program or a script, are executed by the CPU, the computer-readable instructions stored in memory 20 may instruct the CPU or transaction system 30 to perform a plurality of functions. Examples of such functions are described below with respect to FIGS. 3-4.

In some non-limiting embodiments of the present disclosure, the CPU may be transaction system 30. In some implementations, when computer-readable instructions, such as an application program or a script, are executed by the CPU, the computer-readable instructions stored in memory 20 may instruct the transaction system 30 to analyze a transaction request and reserve currency at an ATM. In some non-limiting embodiments, Computer 10 may be located on the user device 120, on a remote server, on the cloud, or any combination thereof. In some non-limiting embodiments, Computer 10 and transaction system 30 communicate with user device 120 via network 80.

I/O device 60 may receive data from network 80, database 90, data from other devices and sensors connected to transaction system 30, and input from a user and provide such information to the transaction system 30. I/O device 60 may transmit data to network 80, database 90, and/or a local database. I/O device 60 may transmit data to other devices connected to transaction system 30, and may transmit information to a user (e.g., display the information, send an e-mail, make a sound) or transmit information formatted for display on a user device 120 or any other device associated with the user. Further, I/O device 60 may implement one or more of wireless and wired communication between user device 120 or transaction system 30 and other devices within or external to network 80. I/O device 60 may receive one or more of data from another server or a network 80. The transaction system 30 may be a processing system, a server, a plurality of servers, or any combination thereof. In addition, I/O device 60 may communicate received input or data from user device 120 to transaction system 30.

Transaction system 30 may be located on the cloud, on an external network, on user device 120, or any combination thereof. Transaction system 30 may be SaaS or entirely located on the user device 120. Furthermore, some non-limiting configurations of transaction system 30 may be located exclusively on a user device 120, such as, for example, a mobile device or tablet. Transaction system 30 may also be accessed by a user on user device 120. In some non-limiting embodiments, the user may connect to network 80 to access transaction system 30 using the user device 120.

Further referring to FIG. 2, in some non-limiting embodiments of the present disclosure, a mobile application may be installed on the user device 120. The mobile application may facilitate communication with transaction system 30, database 90, or any other entity. In some non-limiting embodiments, a program on user device 120 may track, record, and report input information to the transaction system 30, such as, for example, past transaction requests. In systems and methods of the present disclosure, such as when the transaction system 30 is located on user device 120, user device 120 may not be connected to network 80 while in communication with transaction system 30.

In some non-limiting embodiments, user device 120 may store transaction requests, preferred ATMs, previously used ATMS, currency denomination preferences, and any other data associated with the transaction system 30 locally on the user device 120. In some non-limiting embodiments of the present disclosure, an application on the user device 120 may communicate with transaction system 30 to manage analysis, data, and corresponding user input or requests on the user device 120. User device 120 may have a user interface for the user to communicate with transaction system 30. An application on the user device 120 and transaction system 30 may maintain an offline copy of all information. In some non-limiting embodiments of the present disclosure, in which the transaction system 30 is located partially or completely on user device 120, transaction system 30 may facilitate communications regarding transaction requests to a financial institution. In such situations, transaction system 30 may rely on information stored locally on user device 120. User may store ATM preferences, such as a preferred location, on the user device 120. In some systems and methods of the present disclosure, transaction system 30 may rely on information in a cloud database.

Further, transaction system 30 may communicate with an ATM system 35 via the network 80. ATM system 35 may include a single ATM or multiple ATMs. Transaction system 30 may determine whether a transaction request associated with an account would clear the account if the transaction request is processed. The transaction request may originate from a user device 120. Transaction system 30 may determine whether a particular ATM has sufficient resources to service the transaction request. In some non-limiting embodiments, transaction system 30 may determine which of a network of ATMS in the ATM system 35 has sufficient resources to service the transaction request. The ATM system 35 may include multiple ATMs within a predetermined distance of a particular location. For example, in some non-limiting embodiments, transaction system 30 may be able to determine a user location based on the transaction request. In addition, in other non-limiting embodiments, a user may submit a transaction request including a preferred location that differs from a current user location. In some non-limiting embodiments of the present disclosure, a transaction request may include a cap increase request to increase the maximum amount a user can withdraw from an ATM.

FIG. 3 illustrates communication points in a transaction system ecosystem according to a non-limiting embodiment of the present disclosure. In some non-limiting embodiments, a user 100 may submit a transaction request using a user device 120. The transaction request may be sent by the user device 120 to the transaction system 30 via network 80. In some non-limiting embodiments, transaction system 30 may determine whether a transaction request associated with an account would clear the account if the transaction request is processed. Transaction system 30 may communicate with a financial institution to determine whether the account has enough funds to process the transaction request. In some non-limiting embodiments, transaction system 30 may determine whether a particular ATM has sufficient resources to service the transaction request. Transaction system 30 may communicate with multiple ATMs in the ATM system 35 to determine which ATMs have sufficient resources to service the transaction request. In addition, transaction system 30 may transmit an instruction reserving a corresponding amount of currency for the transaction request at a particular ATM for a predetermined time frame. This particular ATM may be determined based on available resources, location, transaction history of the user, a location preference in the transaction request, etc.

For example, in some non-limiting embodiments, a user 100 may use the user device 120 to submit a transaction request to withdraw $100 from an ATM. The request may be received by a transaction system 30. In some non-limiting embodiments, the transaction system 30 may be a financial institution, such as, for example, an issuer bank. The transaction request may be submitted through a mobile application supported by a financial institution. In some non-limiting embodiments, the transaction request may include a preference or priority list of currency denominations for the $100. In some non-limiting embodiments, the transaction request may specify a preference for a type of currency, such as, for example, in Euros before US Dollars.

The transaction system 30 may determine a location of the user device 120 based on the transaction request. In some non-limiting embodiments, the user 100 may indicate a preferred location that differs from the location of the user device 120. Users may submit a list of preferred ATMs or a list of preferred locations with the transaction request. Transaction system 30 may use the location information to determine ATMs near the location that have sufficient resources to fulfill the transaction request. Transaction system 30 may communicate with local and regional data centers 300 to determine suitable ATMs. In addition, transaction system 30 may communicate with a payment network 310 and an issuing bank's data center to determine suitable ATMs to fulfill the transaction request.

Transaction system 30 may list suitable ATMs from which a user may choose where to reserve the $100. In some non-limiting embodiments, transaction system 30 may determine an ATM based on preferred configurations previously set by the user or based on preferences indicated in the transaction request. The amount and reservation time requests by the transaction request may be limited by an issuing bank or financial institution. A user may reserve funds at a specific ATM in the ATM system 35 for future dates. In addition, in some non-limiting embodiments of the present disclosure, a transaction request may reserve funds at a particular ATM for a predetermined time set by a financial institution. At the end of the predetermined time, the funds may be reserved by another user or withdrawn from the particular ATM. In some non-limiting embodiments, the predetermined time may be indicated in a transaction request and determined by a user on user device 120.

Upon receiving a selection, transaction system 30 may communicate with ATM system 35 to reserve the $100 at a particular selected ATM for the time specified. In some non-limiting embodiments, the amount may be reserved at several suitable ATMs for the predetermined time. The user 100 may visit the particular ATM and retrieve the reserved funds after an authentication process. In some non-limiting embodiments, the transaction system 30 may not be able to find a particular ATM suitable to fulfill the transaction request. In this case, the transaction system 30 may notify or indicate to the user 100 when a suitable ATM is available. The transaction system 30 may format indications or notifications for display on a user interface on the user device 120.

FIG. 4 is a flow chart for a method for determining a valid transaction request and reserving currency at a particular ATM according to a non-limiting embodiment of the present disclosure. In step 400, transaction system 30 may determine whether a transaction request associated with an account would clear the account if the transaction request is processed. In some non-limiting embodiments of the present disclosure, transaction system 30 may receive the transaction request from user device 120 over a Short Message Service (SMS) protocol. In addition, transaction system 30 may determine a monetary denomination and currency type based on the transaction request. Any preference indicated in the transaction request may be ranked according to a priority specified in the transaction request. For example, a user may request $100 preferably in fifty dollar bills, but secondarily in twenty dollar bills. In some non-limiting embodiments, transaction system 30 may adjust a maximum withdraw amount of the account based on the transaction request.

Transaction system 30 may determine multiple ATMs within a predetermined range of a current location of a user associated with the account. The transaction system 30 may determine that the predetermined time frame is at a future date based on the transaction request. In other non-limiting embodiments, an issuing bank associated with the account of the user may set a predetermined time frame for a reservation of funds. In some non-limiting embodiments, transaction system 30 may determine an ATM location radius based on the transaction request. The ATM location radius may be based on a current location of the user device 120 or a requested location submitted in the transaction request. In addition, in step 410, transaction system 30 may determine which of multiple ATMs have sufficient resources (e.g., currency, preferred denominations, funds after fulfilling other transaction requests after submission of the user's request) to provide a particular set of currency requested in the transaction request. In some non-limiting embodiments, only a portion of the available ATMS in the ATM location radius may have suitable resources to fulfill the transaction request.

In step 420, transaction system 30 may transmit, to the user associated with the account, a set of ATMs having sufficient resources within the predetermined range of the current location of the user. In some non-limiting embodiments, transaction system 30 may select an ATM instead of providing the set of ATMs to the user for selection. In some non-limiting embodiments of the present disclosure, transaction system 30 may transmit an instruction reserving the particular set of currency for a predetermined time at a particular ATM selected by the user from the set of ATMs. The instruction may reserve a corresponding amount of funds in a preferred currency or denomination(s) based on the transaction request. In some non-limiting embodiments, the account may be associated with a first financial institution and the particular ATM may be associated with a second financial institution. In some non-limiting embodiments, the account may be associated with a first issuing bank, and the particular ATM may be associated with a different issuing bank. In addition, the ATM may process the instruction according to priorities or preferences set forth in the transaction request.

In some non-limiting embodiments, transaction system 30 may transmit, upon expiration of the predetermined time frame, an instruction to an alternate ATM having sufficient resources to service the transaction request. In addition, transaction system 30 may authenticate a transaction initiated by an account holder of the account to withdraw the corresponding amount of currency from the alternate ATM. Furthermore, transaction system 30 may transmit a notification or indication to the user device 120 that the predetermined time frame has ended and that the funds reserved by the transaction request are no longer reserved.

Further, in some non-limiting embodiments, transaction system 30 may authenticate a transaction initiated by an account holder of the account, which may be the user associated with the account, to withdraw the corresponding amount of currency from the particular ATM.

The flowcharts and diagrams in FIGS. 1-4 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, “each” means “each and every” or “each of a subset of every,” unless context clearly indicates otherwise.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method, comprising:
determining, using one or more processors, whether a transaction request associated with an account would clear the account if the transaction request is processed;
determining, using one or more processors, whether a particular Automated Teller Machine (ATMs) has sufficient resources to service the transaction request; and
transmitting, using one or more processors, an instruction reserving a corresponding amount of currency for the transaction request at the particular ATM for a predetermined time frame.

2. The method of claim 1, further comprising:
authenticating, using one or more processors, a transaction initiated by an account holder of the account to withdraw the corresponding amount of currency from the particular ATM.

3. The method of claim 1, further comprising:
determining, using one or more processors, at least one monetary denomination based on the transaction request; and
wherein transmitting the instruction reserving the corresponding amount of currency for the transaction request comprises:
transmitting, using one or more processors, a denomination instruction reserving the corresponding amount of currency in the at least one monetary denomination.

4. The method of claim 1, further comprising:
increasing, using one or more processors, a maximum withdraw amount of the account based on the transaction request.

5. The method of claim 1, wherein determining, using one or more processors, whether a particular Automated Teller Machine (ATM) has sufficient resources to service the transaction request comprises:
determining an ATM location radius based on the transaction request, wherein the particular ATM is located within the ATM location radius.

6. The method of claim 1, wherein the account is associated with a first issuing bank and the particular ATM is associated with a second issuing bank.

7. The method of claim 1, further comprising:
transmitting, upon expiration of the predetermined time frame, an instruction to an alternate ATM having sufficient resources to service the transaction request;
authenticating, using one or more processors, a transaction initiated by an account holder of the account to withdraw the corresponding amount of currency from the alternate ATM.

8. The method of claim 1, further comprising:
determining, using one or more processors, a plurality of monetary denominations based on the transaction request, each monetary denomination ranked according to a priority specified by an account holder of the account;
wherein transmitting the instruction reserving a corresponding amount of currency for the transaction request comprises:
transmitting, using one or more processors, a denomination instruction reserving the corresponding amount of currency according to the ranked plurality of monetary denominations.

9. The method of claim 1, wherein the predetermined time frame is determined by an issuing bank associated with the account.

10. The method of claim 1, wherein the predetermined time frame is at a future date determined based on the transaction request.

11. The method of claim 1, wherein the transaction request is received from a mobile device over a Short Message Service (SMS) protocol.

12. A computer configured to access a storage device, the computer comprising:
a processor; and
a non-transitory, computer-readable storage medium storing computer-readable instructions that when executed by the processor cause the computer to perform:
determining whether a transaction request associated with an account would clear the account if the transaction request is processed;
for each of a plurality of Automated Teller Machines (ATMs), determining whether the ATM has sufficient resources to service the transaction request;
transmitting a set of ATMs having sufficient resources to a user associated with the account; and
transmitting an instruction reserving a corresponding amount of currency for the transaction request for a predetermined time frame at a particular ATM selected by the user from the set.

13. The computer of claim 12, wherein the instructions that when executed by the processor cause the computer to further perform:
authenticating a transaction initiated by the user to withdraw the corresponding amount of currency from the particular ATM.

14. The computer of claim 12, wherein the instructions that when executed by the processor cause the computer to further perform:
determining at least one monetary denomination based on the transaction request; and
wherein transmitting the instruction reserving the corresponding amount of currency for the transaction request comprises:
transmitting a denomination instruction reserving the corresponding amount of currency in the at least one monetary denomination.

15. The computer of claim 12, wherein for each of the plurality of Automated Teller Machines (ATMs), determining whether the ATM has sufficient resources to service the transaction request comprises:
determining a location of the user based on the transaction request; and
determining each of the plurality of ATMs are within a predetermined range of the location.

16. The computer of claim 12, wherein the account is associated with a first issuing bank and the particular ATM is associated with a second issuing bank.

17. The computer of claim 12, wherein the predetermined time frame is determined by an issuing bank associated with the account.

18. The computer of claim 12, wherein the predetermined time frame is at a future date determined based on the transaction request.

19. The computer of claim 12, wherein the transaction request is received from a mobile device of an account holder of the account.

20. A non-transitory computer-readable medium having instructions stored thereon that are executable by a computing system to perform operations comprising:
determining whether a transaction request associated with an account would clear the account if the transaction request is processed;
for each of a plurality of Automated Teller Machines (ATMs) within a predetermined range of a current location of a user associated with the account, determining whether the ATM has sufficient resources to provide a particular set of currency requested in the transaction request;
transmitting, to the user associated with the account, a set of ATMs having sufficient resources within the predetermined range of the current location of the user; and
transmitting an instruction reserving the particular set of currency for a predetermined time at a particular ATM selected by the user from the set of ATMs.
